(19) United States
(12) Patent Application Publication
(10) Pub. No.: US 2015/0129810 A1
(43) Pub. Date: May 14, 2015

(54) METHOD FOR MANUFACTURING A POLYACRYLONITRILE-SULFUR COMPOSITE MATERIAL

(71) Applicant: Robert Bosch GmbH, Stuttgart (DE)

(72) Inventors: Martin Tenzer, Nuertingen (DE); Jean Fanous, Stuttgart (DE)

(73) Assignee: Robert Bosch GmbH, Stuttgart (DE)

(21) Appl. No.: 14/406,290

(22) PCT Filed: Apr. 26, 2013
(86) PCT No.: PCT/EP2013/058762

§ 371 Date: Dec. 8, 2014

(30) Foreign Application Priority Data
Jun. 8, 2012 (DE) 10 2012 209 635.3

(51) Int. Cl. H01M 4/60; H01M 4/62; C08F 120/44

(52) U.S. Cl. CPC H01M 4/604; C08F 120/44; H01M 4/625; H01M 4/623
USPC 252/511; 525/343; 525/329.1; 252/182.1

(57) ABSTRACT

A method is described for manufacturing a polyacrylonitrile-sulfur composite material, including the following method steps: a) providing a matrix material; b) optionally adding sulfur to the matrix material; c) adding polyacrylonitrile to the matrix material to produce a mixture made of sulfur and polyacrylonitrile; and d) reacting sulfur and polyacrylonitrile. A composite material manufactured in this way may be used in particular as an active material of a cathode of a lithium-ion battery and offers a particularly high rate capacity. In addition, methods are provided for manufacturing an active material for an electrode.

### FIELD OF THE INVENTION

The present invention relates to a method for manufacturing a polyacrylonitrile-sulfur composite material, in particular as an active material for an alkali-sulfur battery, in particular for a lithium-sulfur battery. Furthermore, the present invention relates to a method for manufacturing an active material.

### BACKGROUND INFORMATION

To manufacture batteries having a large energy density, research is presently being done on lithium-sulfur battery technology (in short: Li/S). If the cathode of a lithium-sulfur cell were made completely of elementary sulfur, an energy content of greater than 1000 Wh/kg could theoretically be achieved. However, elementary sulfur is neither ionically nor electrically conductive, so additives must be added to the cathode, which significantly reduce the theoretical value. In addition, elementary sulfur is conventionally reduced during the discharge of a lithium-sulfur cell to form soluble polysulfides Sₓ²⁻. These may diffuse into areas, for example, the anode area, in which they may no longer participate in the electrochemical reaction of the following charge/discharge cycles. In addition, polysulfides may be dissolved in the electrolyte, which may not be reduced further. In practice, the sulfur utilization and therefore the energy density of lithium-sulfur cells is presently significantly lower and is currently estimated to be between 400 Wh/kg and 600 Wh/kg.

With regard to lithium-sulfur cells, Nazar et al. in Nature Materials, Vol. 8, June 2009, [pp] 500-506 describe that carbon nanotubes promote retention of polysulfides in the cathode chamber and ensure sufficient electrical conductivity at the same time. An improvement may be achieved by carbon nanotubes which are surface-modified using polyethylene glycol, which have an affinity for polysulfides and may therefore hold them even better in the cathode matrix.

Wang et al. describe in Advanced Materials, 14, 2002, Nr. 13-14, pp 963-965 and Advanced Functional Materials, 13, 2003, Nr. 6, pp 487-492 and Yu et al. describe in Journal of Electroanalytical Chemistry, 573, 2004, 121 -128 and Journal of Power Sources 146, 2005, [pp] 335-339 another technology in which polyacrylonitrile (in short: PAN) is heated with an excess of elementary sulfur, the sulfur, on the one hand, being cyclized, while forming H₂S polyacrylonitrile, to form a polymer having a conjugated π-system and, on the other hand, being bonded in the cyclized matrix, in particular via carbon-sulfur bonds.

### Summary

An object of the present invention is a method for manufacturing a polyacrylonitrile-sulfur composite material, including the following method steps:
a) providing a matrix material;
b) optionally adding sulfur to the matrix material;
c) adding polyacrylonitrile to the matrix material to produce a mixture made of sulfur and polyacrylonitrile; and
d) reacting sulfur and polyacrylonitrile.

A polyacrylonitrile-sulfur composite material (SPAN) may be understood in particular as a composite material which is manufactured by a reaction of polyacrylonitrile (PAN) with sulfur (S).

By way of an above-described method, in particular a polyacrylonitrile-sulfur composite material having a defined structure, a good electrochemical cycle stability, and a high discharge rate (C rate) may be produced, which may be suitable in particular for manufacturing an active material for a cathode in an electrochemical energy store, such as a lithium-sulfur battery in particular.

In a first method step a), a matrix material is provided in the case of an above-described method. The matrix material may fulfill the task in particular of producing a matrix for a reaction of sulfur and polyacrylonitrile, which is carried out in a following step. For example, the matrix material may be solid or liquid. The matrix material may furthermore be formed as a melt as a function of the selected temperature.

Sulfur is optionally added to this provided matrix material, in a further method step b), for the case in which the matrix material does not include sulfur. The sulfur is used for the later reaction with polyacrylonitrile. In addition to the sulfur, polyacrylonitrile is added to the matrix material in a further method step c). The sulfur or the polyacrylonitrile may fundamentally be added to the matrix material in a freely selectable sequence. It is important that a mixture made of sulfur and polyacrylonitrile is produced. A suitable temperature may already be selected during the addition of the sulfur or the polyacrylonitrile, so that the sulfur may be provided as a sulfur melt, for example. Furthermore, the matrix material may be provided in a ratio of less than 1:1 (wt.-%) to the polyacrylonitrile. In a further method step d), the polyacrylonitrile is reacted with the sulfur. A polyacrylonitrile-sulfur composite material results.

The reaction of the sulfur with the polyacrylonitrile may be carried out in particular under an excess of sulfur, and/or at an elevated temperature, i.e., at a temperature elevated in relation to room temperature, such as 22° C. in particular.

The reaction may be carried out in less than 12 hours, in particular less than eight hours, for example, five hours to seven hours, for example, in approximately six hours. In particular, during the reaction, initially a first temperature, for example, in a range of greater than or equal to 250° C. to less than or equal to 450° C., and then a second temperature, which is higher than the first temperature, for example, in a range of greater than or equal to 400° C. to less than or equal to 600° C., may be set. The phase within which the second temperature is set may be longer in particular than the phase in which the first temperature is set. Cyclization of the polyacrylonitrile may be caused by the first temperature phase. The formation of covalent sulfur-carbon bonds may essentially be carried out during the second temperature phase. Because a lower temperature is set in this case, longer polysulfide chains may be linked to the cyclized polyacrylonitrile framework.

Because a matrix material is provided in a first step for producing the composite material, and the actual reactants, such as the polyacrylonitrile in particular, are added to the matrix material, an agglomeration of the polyacrylonitrile particles may be prevented in particular. Rather, the composite particles thus formed precipitate out as a fine composite made of small particles. For example, for the use of such a composite material as an active material in a cathode, a particularly homogeneous distribution of the composite particles may thus be achieved.

The advantage thus achievable may be seen for the exemplary case of a use as an active material in a lithium-sulfur battery, for example, in particular in the short diffusion paths for lithium ions in the composite. In detail, during the charging operation, lithium ions are transported through the electrolyte to the polyacrylonitrile-sulfur composite particles. Since the reduction of the composite or the sulfur contained in the composite takes place in the solid, the ion travel must take place through the particles. Therefore, a smaller diameter and therefore a shorter diffusion length may be achieved by smaller, finer particles, which may in turn result in higher discharging and charging rates. In addition to the shorter diffusion paths, the overvoltage may also be lower.

A composite material may thus be manufactured by a method according to the present invention, which may produce improved charging or discharging rates in particular as an active material in a lithium-ion battery.

In the case of such composite materials, suggestions furthermore exist of a sulfur-carbon bond, which therefore fixedly bonds the polysulfides on the polymer matrix. A sulfur-polyacrylonitrile composite therefore results having various functional groups and chemical bonds, which may all have different properties and contributions with respect to electrochemical performance and aging behavior.

Accompanying this, the advantage may be achieved by the method according to the present invention that the manufactured composite material experiences a lower capacitance drop in particular in the case of large current intensities, i.e., a particularly stable capacitance may be obtained.

Such a composite material according to the present invention may be manufactured particularly simply, since in particular the use of complex and multistage syntheses may be omitted. In contrast thereto, the method according to the present invention may be carried out particularly simply and cost-effectively, so that also the composite material or the active material as well as an electrode or battery equipped with the composite material may be manufactured particularly cost-effectively.

Such a polyacrylonitrile-sulfur composite material may be manufactured, which may be used particularly advantageously as a cathode material for alkali-sulfur cells, in particular lithium-sulfur cells, in particular to achieve good long-term stability or electrochemical cycle stability and particularly high electrical conductivity, including a good rate capacity.

Within the scope of one embodiment, in method step c), a mixture of sulfur and polyacrylonitrile may be produced in a range of greater than or equal to 7.5:1 (wt.-%). In particular by way of an increased proportion of sulfur, the polyacrylonitrile particles may be well separated from one another, on the one hand, which may result in particularly small composite particles, since the polyacrylonitrile particles are separated from one another not only by the matrix material, but similarly by the sulfur. In addition, particularly good contact of each individual polyacrylonitrile particle with the sulfur may be achieved, which may also increase the sulfur content in the composite particles to be manufactured. Thus, for the exemplary case of the use of such a composite material as an active material in an electrode for a lithium-ion battery, a particularly high capacitance may be achieved. Therefore, in this embodiment, not only is the rate capacity particularly improved in a particularly advantageous way, but rather at the same time the capacitance is increased. In addition, in this embodiment the effect that a reduction of the sulfur content may take place in the event of an increase of the temperature may be compensated for. Therefore, in particular in this embodiment high temperatures may also be used while forming a composite material having a high capacitance.

For example the weight ratio of sulfur to polyacrylonitrile, in particular cyclized polyacrylonitrile, may be greater than or equal to 7.5:1 (wt.-%), in particular less than or equal to 20:1 (wt.-%). The excess elementary sulfur used during the manufacturing may be removed thereafter, for example, by sublimation in the case of high reaction temperatures or as explained hereafter, by a Soxhlet extraction. In particular a composite material having a particularly advantageous conductivity may be produced by a sulfur excess, which further positively influences the rate capacity.

Within the scope of one further embodiment, in method step d), polyacrylonitrile may be reacted with sulfur at a temperature in a range of greater than or equal to 250° C., in particular in a range of greater than or equal to 450° C. At such temperatures, on the one hand, particularly good reactivity may be achievable and furthermore the sulfur may be provided as a melt, which may enable a particularly reactive reaction of the sulfur with the polyacrylonitrile. In addition, in particular if the sulfur is provided as a melt, it may completely enclose the polyacrylonitrile particles in particular and therefore cause particularly small polyacrylonitrile-sulfur particles to be formed, which react preferably well with the sulfur, and therefore a high sulfur content is obtained.

Within the scope of another embodiment, the matrix material may be selected from the group including sulfur, silicon compounds, such as silicon dioxide, and/or carbon modifications. In particular in the case of the use of sulfur as a matrix material, each polyacrylonitrile particle may be enclosed by sulfur and therefore a polyacrylonitrile-sulfur composite material may be formed, which has a particularly high sulfur proportion. The capacitance may thus be particularly high, for example, in the case of the use as an active material in an electrode. In addition, sulfur has a low melting point, so that sulfur may be present as a melt already at comparatively low temperatures, whereby the polyacrylonitrile particles may particularly advantageously be separated and agglomeration may be prevented. Furthermore, the advantage suggests itself that in this embodiment a reaction of sulfur with polyacrylonitrile essentially may only be carried out with the use of only sulfur and polyacrylonitrile, whereby the addition of further materials may be omitted. The method is thus possible particularly simply and cost-effectively in this embodiment. With respect to the silicon compounds and the carbon modifications, an inert matrix may furthermore be provided, in which the sulfur may be reacted with the polyacrylonitrile in a particularly defined way.

Within the scope of another embodiment, the composite material may be manufactured in particles of a size in a range of greater than or equal to 100 nm to less than or equal to 50 μm. In particular such particles have a particularly small size, so that the diffusion paths, for example, for lithium ions, may be particularly short. Particularly improved rate behavior thus suggests itself in particular in the case of the production of such particles.

Within the scope of another embodiment, the method may include the following further method step:
e) purifying the produced composite material.

The polyacrylonitrile-sulfur composite material may be separated in particular from excess matrix material and/or sulfur by a purification and therefore may assume a particularly defined structure without the risk of further changes. In addition, a composite material may be used directly as an active material after the purification. The composite material may be dried in particular after the purification.

Within the scope of another embodiment, the purification according to method step e) may be carried out by a Soxhlet extraction, in particular the Soxhlet extraction being carried out with use of an organic solvent. In particular, the Soxhlet extraction may be carried out using an apolar solvent or solvent mixture, for example, toluene, and the excess sulfur may be removed. A Soxhlet extraction is a particularly simple and cost-effective method and is particularly gentle for the manufactured composite material, so that no structural change of the particles may take place during the purification. The rate capacity may thus remain particularly stable.

Within the scope of another embodiment, at least method step d) may be carried out under an inert gas atmosphere. Surprisingly, it has been found that an inert gas atmosphere may contribute to obtaining a particularly homogeneous and defined structure of the polyacrylonitrile-sulfur composite material. An inert gas atmosphere may be understood in particular as an atmosphere of a gas which is nonreactive in the case of the conditions prevailing during method step d). For example, an inert gas atmosphere may be formed by argon or nitrogen.

Within the scope of another embodiment, in method step c), a cyclized polyacrylonitrile may be added to the matrix material, the cyclized polyacrylonitrile being obtained by reacting polyacrylonitrile to form cyclized polyacrylonitrile.

In a first method step, for example, initially an electrically conductive base in the form of the electrically conductive, cyclized polyacrylonitrile (cPAN) may be produced. In a further method step, the reaction with the electrochemically active sulfur may be carried out, in particular this being covalently bonded to the electrically conductive framework made of cyclized polyacrylonitrile while forming a polyacrylonitrile-sulfur composite material (ScPan). The reaction conditions may advantageously be optimized to the particular reaction by a separation into two partial reactions. The first method step is similar to a dehydration reaction known from carbon fiber manufacturing, the second method step being similar to a reaction from a further, completely different technical field, namely the vulcanization reaction of rubber.

The cyclization may be carried out in particular in an oxygenated atmosphere, for example, an air or oxygen atmosphere. The cyclization may be carried out, for example, at a temperature in a range of greater than or equal to 150° C. to less than or equal to 500° C., in particular greater than or equal to 150° C. to less than or equal to 330° C. or less than or equal to 300° C. or less than or equal to 280° C., for example, greater than or equal to 230° C. to less than or equal to 270° C. The reaction time of the first method step may advantageously be less than 3 hours, in particular less than 2 hours, for example, less than 1 hour. In particular, the first method step may be carried out in the presence of a cyclization catalyst. For example, catalysts known from carbon fiber manufacturing may be used as cyclization catalysts. The reaction temperature and/or the reaction time of the reaction of the polyacrylonitrile with the sulfur may advantageously be reduced by the addition of a cyclization catalyst.

The sulfur atoms may be bonded to the cyclized polyacrylonitrile framework in the polyacrylonitrile-sulfur composite material both directly by covalent sulfur-carbon bonds and also indirectly by one or multiple covalent sulfur-sulfur bonds and one or multiple sulfur-carbon bonds.

Alternatively or additionally thereto, a part of the sulfur atoms of the polyacrylonitrile-sulfur composite material, for example, in the form of polysulfide chains, may be covalently bonded on both sides intra-molecularly with a cyclized polyacrylonitrile strand, in particular with formation of an S-heterocycle fused on the cyclized polyacrylonitrile strand, and/or intermolecularly with two cyclized polyacrylonitrile strands, in particular with formation of a bridge, in particular a polysulfide bridge, between the cyclized polyacrylonitrile strands.

Within the scope of another embodiment, polyacrylonitrile may be reacted with sulfur in method step d) in the presence of a catalyst. The reaction temperature and the reaction time may advantageously be reduced by the addition of a catalyst. By reducing the reaction temperature, in addition the chain length of polysulfides which are covalently bonded to the cyclized polyacrylonitrile may also be increased. This is because elementary sulfur exists at room temperature in the form of S8 rings. At temperatures above room temperature, sulfur exists in the form of Sx chains of moderate chain length, for example, of 6 to 26 sulfur atoms, or long chain length, for example, of 103 to 106 sulfur atoms. A thermal cracking process begins above 187° C. and the chain length decreases again. From 444.6° C. (boiling point), gaseous sulfur having a chain length of 1-8 atoms exists. The use of a vulcanization catalyst has the advantage that at a lower temperature, longer intermolecular and/or intramolecular sulfur bridges, which are covalently bonded to polyacrylonitrile, in particular cyclized polyacrylonitrile, may be introduced into the polyacrylonitrile-sulfur composite material. Thus, a high sulfur content of the polyacrylonitrile-sulfur composite material and therefore a higher capacitance and energy density of the alkali-sulfur cell to be equipped with the cathode material, in particular a lithium-sulfur cell, may advantageously again be achieved. This may result in a reduction of the cycle stability, which may be compensated for by the selection of a suitable electrolyte, however.

Suitable catalysts are known from the technical field of rubber vulcanization. The reaction is therefore preferably carried out in this case at least sometimes in the presence of a vulcanization catalyst or vulcanization accelerator. In particular, the vulcanization catalyst or vulcanization accelerator may include at least one sulfide radical starter or may be made thereof. In particular, the sulfide radical starter may be selected from the group including sulfide metal complexes, for example, obtainable by reaction of zinc oxide (ZnO) and tetramethyl thiuram disulfide or N, N-dimethyl thiocarbamate, sulfene amides, for example, 2-mercaptobenzothiazole amine derivatives, and combinations thereof. For example, the reaction mixture may include greater than or equal to 3 wt.-% to less than or equal to 5 wt.-% zinc oxide and optionally greater than or equal to 0.5 wt.-% to less than or equal to 1 wt.-% tetramethyl thiuram disulfide. To reduce the reaction speed or be able to end a reaction phase at an increased reaction speed, for example, due to the catalyst, the reaction is carried out at least temporarily in the presence of a vulcanization inhibitor. Vulcanization inhibitors suitable for this purpose are also known from the technical field of rubber vulcanization. For example, N-(cyclohexylthio) phthalamide may be used as a vulcanization inhibitor. The properties of the polyacrylonitrile-sulfur composite material may be set in a targeted way by the use and the duration of the use of the catalyst, in particular the vulcanization catalyst or vulcanization accelerator and/or vulcanization inhibitor. The catalyst and optionally the inhibitor are optionally partially or completely removed in a removal step.

With regard to further features and advantages of the method according to the present invention for manufacturing a polyacrylonitrile-sulfur composite material, reference is hereby explicitly made to the explanations in conjunction with the method according to the present invention for manufacturing an active material for an electrode and its use.

The object of the present invention is furthermore a method for manufacturing an active material for an electrode, in particular for a cathode of a lithium-sulfur battery, including a method as described above for manufacturing a polyacrylonitrile-sulfur composite material. The fact may be utilized in particular here that a polyacrylonitrile-sulfur composite material manufactured as described above may have advantageous properties, such as a high rate capacity in particular, in particular as an active material of an electrode, in particular a cathode, for a lithium-sulfur battery. An energy store equipped therewith may thus have a particularly preferred charging and/or discharging behavior.

Within the scope of one embodiment, the method may furthermore include the following method step:
f) admixing at least one electrically conductive additive to the polyacrylonitrile-sulfur composite material, in particular selected from the group including carbon black, graphite, carbon fibers, carbon nanotubes, and mixtures thereof.

As an example, greater than or equal to 0.1 wt.-% to less than or equal to 30 wt.-%, for example, greater than or equal to 5 wt.-% to less than or equal to 20 wt.-%, of electrically conductive additives may be admixed. The conductivity and therefore the rate capacity of the mixture obtained may be further improved by admixing an electrically conductive additive, which makes a use as an active material in an electrode particularly advantageous.

Within the scope of another embodiment, the method may furthermore include the following method step:
g) admixing at least one binder, in particular polyvinylidene fluoride and/or polytetrafluoroethylene, to the polyacrylonitrile composite material.

Greater than or equal to 0.1 wt.-% to less than or equal to 30 wt.-%, for example, greater than or equal to 5 wt.-% to less than or equal to 20 wt.-% of binders may be admixed. Furthermore, the binder or binders may be admixed with the addition of N-methyl-2-pyrrolidone as a solvent. In particular the stability of the cathode material may be improved by admixing binders, which may improve a use in electrochemical energy stores.

Within the scope of another embodiment,
in method step f) and/or in method step g), greater than or equal to 60 wt.-% to less than or equal to 90 wt.-%, in particular greater than or equal to 65 wt.-% to less than or equal to 95 wt.-%, for example, 70 wt.-% polyacrylonitrile-sulfur composite material may be used, and/or
in method step f), greater than or equal to 0.1 wt.-% to less than or equal to 30 wt.-%, for example, greater than or equal to 5 wt.-% to less than or equal to 20 wt.-% electrically conductive additives may be admixed, and/or
in method step g), greater than or equal to 0.1 wt.-% to less than or equal to 30 wt.-%, for example, greater than or equal to 5 wt.-% to less than or equal to 20 wt.-% binders may be admixed.

The sum of the wt.-% values of polyacrylonitrile-sulfur composite material, electrically conductive additives, and binders may result in particular in a total of 100 wt.-%, depending on the usage.

With respect to further features and advantages of the method according to the present invention for manufacturing an active material for an electrode, reference is hereby explicitly made to the explanations in conjunction with the method according to the present invention for manufacturing a polyacrylonitrile-sulfur composite material and its use.

The object of the present invention is furthermore a use of a polyacrylonitrile-sulfur composite material, manufactured as explained above, as an active material in an electrode, in particular in a cathode of a lithium-ion battery.

With respect to particular features and advantages of the use according to the present invention, reference is hereby explicitly made to the explanations in conjunction with the method according to the present invention for manufacturing a polyacrylonitrile-sulfur composite material and the method for manufacturing an active material for an electrode.

An active material formed as described above may be used hereafter particularly advantageously for manufacturing an energy store.

For the embodiment of such an energy store, the active material may include a polyacrylonitrile-sulfur composite material manufactured as described above, in particular for forming a slurry for manufacturing a cathode, furthermore admixed with at least one solvent, for example, N-methyl-2-pyrrolidone. Such a slurry may be applied, for example, by a doctor blade, to a carrier material, for example, an aluminum plate or foil. The solvents are removed again, preferably completely, in particular by a drying method, preferably after the application of the active material and prior to the assembly of the lithium-sulfur cell.

The active material-carrier material assembly may subsequently be divided into multiple active material-carrier material units, for example, by stamping or cutting.

The active material-carrier material assembly or units may be assembled with a lithium metal anode, for example, in the form of a plate or foil made of metallic lithium, to form a lithium-sulfur cell.

In particular an electrolyte may be added. The electrolyte may be formed in particular from at least one electrolyte solvent and at least one conducting salt. The electrolyte solvent may fundamentally be selected from the group including carboxylic acid esters, in particular cyclic or acyclic carbonates, lactones, ethers, in particular cyclic or acyclic ethers, and combinations thereof. For example, the electrolyte solvent may include diethyl carbonate (DEC), dimethyl carbonate (DMC), propylene carbonate (PC), ethylene carbonate (EC), 1,3-dioxolane (DOL), 1,2-dimethoxyethane (DME) or a combination thereof or may be made thereof. The conducting salt may be selected, for example, from the group including lithium hexafluorophosphate (LiPF₆), lithium bis (trifluoromethyl sulfonyl) imide (LiTFSI), lithium tetrafluoroborate (LiBF₄), lithium trifluoromethane sulfonate (LiCF₃SO₃), lithium chlorate (LiClO₄), lithium bis (oxalato) borate (LiBOB), lithium fluoride (LiF), lithium nitrate (LiNO₃), lithium hexafluoroarsenate (LiAsF₆), and combinations thereof.

With respect to the above-mentioned active materials, in particular to avoid reactions between the elementary sulfur and the electrolyte, cyclic ethers, acyclic ethers, and combinations thereof as solvents, and/or lithium bis (trifluoromethyl sulfonyl) imide (LiTFSI) as a conducting salt have proven to be particularly advantageous.

Such an energy store may in particular be a mobile or stationary energy store. For example, the energy store may be an energy store for a vehicle, for example, an electric or hybrid vehicle, or a power tool or electrical device, for example, a screwdriver or a gardening device, or an electronic device, for example, a portable computer and/or a telecommunications device, such as a mobile telephone, PDA, or a high-energy storage system for a house or a facility. Since the alkali-sulfur cells or batteries according to the present invention have a very high energy density, they are particularly suitable for vehicles and stationary storage systems, such as high-energy storage systems for houses or facilities.

### DETAILED DESCRIPTION

Further advantages and advantageous embodiments of the objects according to the present invention are illustrated by the example and explained in the following description. It is to be noted that the example only has descriptive character and is not intended to restrict the present invention in any form.

An example is shown hereafter of manufacturing a polyacrylonitrile-sulfur composite material according to the present invention or an active material based thereon or an electrode according to the present invention for a lithium-sulfur battery. Such energy stores are advantageous in particular for all applications which are equipped with a battery having high performance. These may be electrically driven vehicles, such as hybrid vehicles, power tools, notebooks, mobile telephones or gardening devices, but also stationary high-energy storage systems for houses or facilities.

In a first step, a matrix material is provided, which may include sulfur, for example. In this case, a sulfur melt (for example, 100 g) is provided, for example, at a temperature of 250° C. Subsequently, either pure polyacrylonitrile or a mixture of polyacrylonitrile and sulfur is successively added by stirring (for example, 1 g PAN). Subsequently, the mixture may be stirred further for some time, for example, 2 hours, at 250° C., and then may be heated to a higher temperature, for example, 330° C. The reaction is subsequently continued for additional hours, in particular 4 hours.

After cooling of the melt, the manufactured composite material may be treated using hot toluene, for example, to remove a majority of the sulfur. Subsequently, the final purification of the composite may be carried out in a Soxhlet extraction, for example.

In a next step, the sulfurous, cyclized polyacrylonitrile, i.e., the finished composite, is processed to form a cathode slurry to implement a cathode-active material. For this purpose, the active material (SPAN), carbon black (for example, carbon black available under the trade name Super P Li) as an electrically conductive additive, and polyvinylidene fluoride (PVDF) as a binder are mixed and homogenized in a ratio of 70:15:15 (in wt.-%) in N-methyl-2-pyrrolidone (NMP) as a solvent. The slurry is spread by a doctor blade onto an aluminum foil and dried. After complete drying, a cathode is stamped out and installed in a test cell against a lithium metal anode. Various cyclic and linear carbonates (DEC, DMC, EC) and mixtures thereof with a lithium-containing conducting salt (for example, LiPF₆, lithium-bis (trifluoromethane sulfonyl) imide (LiTFSI)) are used as the electrolyte.

1.-15. (canceled)

16. A method for manufacturing a polyacrylonitrile-sulfur composite material, comprising:
a) providing a matrix material;
b) optionally adding sulfur to the matrix material;
c) adding polyacrylonitrile to the matrix material to produce a mixture made of sulfur and polyacrylonitrile; and
d) reacting sulfur and polyacrylonitrile.

17. The method as recited in claim 16, wherein, in method step c), a mixture of sulfur and polyacrylonitrile in a range of greater than or equal to 7.5:1 is produced.

18. The method as recited in claim 16, wherein, in method step d), polyacrylonitrile is reacted with sulfur at a temperature in a range of greater than or equal to 250° C.

19. The method as recited in claim 16, wherein, in method step d), polyacrylonitrile is reacted with sulfur at a temperature in a range of greater than or equal to 450° C.

20. The method as recited in claim 16, wherein the matrix material is selected from the group including at least one of sulfur, silicon compounds, silicon dioxide, and carbon modifications.

21. The method as recited in claim 16, wherein the composite material is manufactured in particles of a size in a range from greater than or equal to 100 nm to less than or equal to 50 μm.

22. The method as recited in claim 16, further comprising:
e) purifying the produced composite material.

23. The method as recited in claim 22, wherein the purification according to method step e) is carried out by a Soxhlet extraction.

24. The method as recited in claim 23, wherein the Soxhlet extraction is carried out with use of an organic solvent.

25. The method as recited in claim 16, wherein at least method step d) is carried out under an inert gas atmosphere.

26. The method as recited in claim 16, wherein, in method step c), a cyclized polyacrylonitrile is added to the matrix material, the cyclized polyacrylonitrile being obtained by reacting polyacrylonitrile to form cyclized polyacrylonitrile.

27. The method as recited in claim 16, wherein, in method step d), polyacrylonitrile is reacted with sulfur in the presence of a catalyst.

28. A method for manufacturing an active material for an electrode including a method for manufacturing a polyacrylonitrile-sulfur composite material, comprising:
a) providing a matrix material;
b) optionally adding sulfur to the matrix material;
c) adding polyacrylonitrile to the matrix material to produce a mixture made of sulfur and polyacrylonitrile; and
d) reacting sulfur and polyacrylonitrile.

29. The method as recited in claim 28, wherein the electrode is a cathode of a lithium-sulfur battery.

30. The method as recited in claim 28, further comprising:
f) admixing at least one electrically conductive additive to the polyacrylonitrile-sulfur composite material.

31. The method as recited in claim 30, wherein the electrically conductive additive is selected from the group including carbon black, graphite, carbon fibers, carbon nanotubes, and mixtures thereof

32. The method as recited in claim 30, further comprising:
g) admixing at least one binder to the polyacrylonitrile-sulfur composite material.

33. The method as recited in claim 32, wherein the binder includes at least one of polyvinylidene fluoride and polytetrafluoroethylene.

34. The method as recited in claim 32, wherein:
in method step f) and/or in method step g), greater than or equal to 60 wt.-% to less than or equal to 90 wt.-%, in particular greater than or equal to 65 wt.-% to less than or equal to 75 wt.-%, for example, 70 wt.-% polyacrylonitrile-sulfur composite material may be used, and/or
in method step f), greater than or equal to 0.1 wt.-% to less than or equal to 30 wt.-%, for example, greater than or equal to 5 wt.-% to less than or equal to 20 wt.-% electrically conductive additives may be admixed, and/or
in method step g), greater than or equal to 0.1 wt.-% to less than or equal to 30 wt.-%, for example, greater than or equal to 5 wt.-% to less than or equal to 20 wt.-% binders may be admixed.

35. A method of using a polyacrylonitrile-sulfur composite material, comprising:
using the polyacrylonitrile-sulfur composite material as an active material in an electrode, the polyacrylonitrile-sulfur composite material being manufactured according to a method for manufacturing a polyacrylonitrile-sulfur composite material, comprising:
a) providing a matrix material;
b) optionally adding sulfur to the matrix material;
c) adding polyacrylonitrile to the matrix material to produce a mixture made of sulfur and polyacrylonitrile; and
d) reacting sulfur and polyacrylonitrile.

36. The method as recited in claim 35, wherein the electrode is a cathode of a lithium-ion battery.
